(19) United States
(12) Patent Application Publication
(10) Pub. No.: US 2012/0275071 A1
(43) Pub. Date: Nov. 1, 2012

(54) ARC-FAULT DETECTION

(75) Inventors: Keith Gordon Gutierrez, Plano, TX (US); Leland Scott Swanson, McKinney, TX (US)

(73) Assignee: TEXAS INSTRUMENTS INCORPORATED, Dallas, TX (US)

(21) Appl. No.: 13/194,456

(22) Filed: Jul. 29, 2011

Related U.S. Application Data
(60) Provisional application No. 61/480,227, filed on Apr. 28, 2011.

(51) Int. Cl. H02H 3/08; H02H 3/16

(52) U.S. Cl. 361/42

(57) ABSTRACT

An arc-fault circuit-interrupter includes a capability for a controller in the interrupter-circuit to be placed in a learn mode. In learn mode, the controller may change firmware to reduce the probability of false tripping or nuisance tripping. Alternatively, in learn mode, the controller may store a signature to be used as the normal signature for a dedicated load.

### RELATED APPLICATION

This application claims the benefit of U.S. Provisional Application No. 61/480,227, filed 28 Apr. 2011. U.S. Provisional Application No. 61/480,227 is hereby incorporated by reference for all that it teaches and discloses.

### BACKGROUND

In electrical power distribution, various types of circuit interrupters disconnect power, to protect people and property, when certain types of faults are detected. Conventional circuit breakers disconnect power if current exceeds a specified threshold for a specified amount of time. Ground-Fault Circuit-Interrupters (GFCI) disconnect power if the electric current in an energized conductor is different than the current in a neutral return conductor. Arc-Fault Circuit-Interrupters (AFCI) disconnect power if hazardous electric arcing is detected. Devices also exist that combine series arc detection, parallel arc detection, conventional excess current detection, and detection of other faults such as leakage.

An arc is defined as a luminous discharge of electricity across an insulating medium. An arc can cause a fire once the electrical energy from the arc is converted to thermal energy. The heat generated is then transferred to a combustible material that ignites. Various types of damage, wear, improper installation, or other faults, may cause arcing between two conductors, or between the ends of two parts of a broken or weakened conductor, or across a loose connection. These hazardous arcs may draw a current that is below the trip threshold (current times time) for conventional circuit breakers, and may not cause unbalanced current flow for detection by ground-fault interrupters, but may still generate sufficient heat to cause a fire. However, electrical arcing may also occur during normal operation of some devices. For example, motor brushes in motors commonly used in vacuum cleaners, kitchen appliances, and electric gardening equipment, may generate arcs during normal operation. Bimetal contacts used for temperature regulation in electric irons and cooking appliances may generate arcs during normal operation. Operation of switches for electric lighting, or insertion or removal of an electrical power cord at an outlet, may generate an arc. Some devices generate electrical characteristics (for example, current spikes) that are similar to the electrical characteristics of arcing. For example, electric light dimmers create periodic current spikes. Switching power supplies used by computers generate distorted current waveforms. AFCI's must be able to distinguish between arcing that occurs during normal operation, or electrical characteristics that are similar to the electrical characteristics of arcing, and hazardous arcing that may cause a fire.

A typical AFCI includes a controller that has been configured to distinguish between normal arcing, or electrical characteristics that are similar to the electrical characteristics of arcing, and unintentional hazardous arcing. The algorithms are typically proprietary, and the algorithms vary from manufacturer to manufacturer. The algorithms are typically capable of detecting most hazardous arcing, but sometimes may disconnect power to a normally functioning device. It is impractical to characterize the normal operation of every available appliance or device that might be attached to an AFCI. In addition, as technology changes, and as new appliances are introduced, some new technologies or appliances may have normal operating electrical current waveform characteristics that are different than the characteristics used for developing the algorithms for installed AFCI's. False tripping or nuisance tripping may be costly or dangerous to a consumer. For example, a consumer may install, or have installed, a different brand of AFCI with different algorithms, or a newer AFCI with updated algorithms. Alternatively, a frustrated consumer may choose to defeat AFCI protection by replacing the AFCI device with a conventional outlet or breaker.

There is an ongoing need for improved AFCI devices.

### BRIEF DESCRIPTION OF THE DRAWINGS

FIG. 1 is a simplified block diagram illustrating an example embodiment of an improved circuit interrupter including arc fault detection.

FIG. 2A is a flow chart illustrating an example embodiment of a method for controlling the circuit interrupter of FIG. 1 while in Learn Mode.

FIG. 2B is a flow chart illustrating an example embodiment of additional detail for part of FIG. 2A.

FIG. 2C is a flow chart illustrating an example alternative embodiment for part of FIG. 2A.

### DETAILED DESCRIPTION

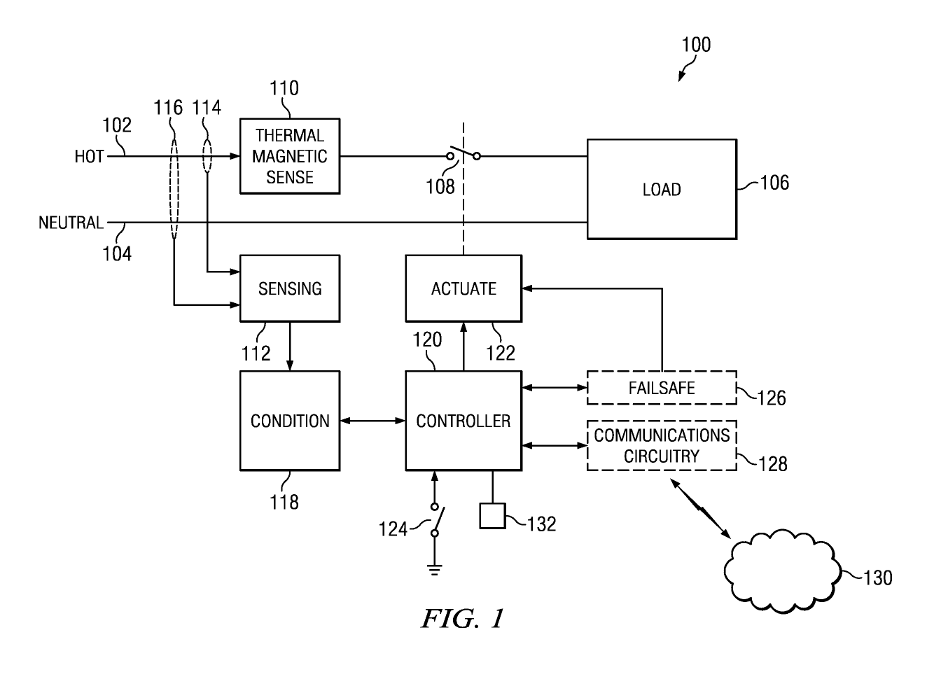

FIG. 1 is a simplified block diagram illustrating an example embodiment of an improved circuit interrupter 100 that includes current overload protection, leakage protection, and arc fault protection. In the example of FIG. 1, a hot power line 102 and a neutral line 104 provide power to a load 106. A switch 108 interrupts power to the load. Switch 108 may be a mechanical interrupter or an electronic interrupter. A thermal magnetic sense device 110 interrupts the power in case of current overload. Current and voltage waveforms are sensed by Sensing circuitry 112. In the example depicted in FIG. 1, the Sense circuitry 112 senses current in the hot line 102 using a sensor 114, and senses leakage current using a sensor 116. Current and voltage waveforms sensed by Sensing circuit 112 are conditioned by Condition circuitry 118. Condition circuitry 118 performs analog processing and generates digital signals suitable for input to a Controller 120. There is a power supply (not illustrated) for the electronic circuitry. Controller 120 may be a microprocessor, a microcontroller, a digital signal processor, a digital signal controller, or an application specific integrated circuit (ASIC) configured to perform the various algorithms. The basic system blocks can be integrated into a monolithic chip, kept as separate chips and interconnected on a circuit board, or implemented as a multi-chip module. Device 110 is depicted as a thermal magnetic sense device, but other types of devices may be used to detect current overload. In the example depicted in FIG. 1, only the hot line 102 is interrupted, but both the hot and neutral lines may be interrupted.

The following attributes characterize hazardous arcing: amplitude, frequencies or frequency band, and periodicity. Hazardous arcing typically results in chaotic bursts of current spikes. Arcing current spikes are typically in the millisecond range. The spikes may have high amplitude, may vary in amplitude, the spikes are typically not periodic (but may be periodic over a relatively long time period), the spikes typically are extinguished during zero-crossings of an AC voltage, and the spikes typically occur at different times within consecutive half-waves of an AC voltage. In contrast, motor brush arcing tends to be periodic, and dimmer switch current spikes tend to occur at a constant phase of an AC voltage. For hazardous arcing, the total number of current spikes in a burst may be different than the total number of current spikes in a burst from motor brush arcing. For hazardous arcing, the distribution of current spike amplitudes may be different than the distribution of current spike amplitudes for normal arcing. For hazardous arcing, the integral of the current spike amplitudes over a predetermined time may be different than the integral of the current spike amplitudes of the predetermined time for normal arcing. The frequency spectra of current spikes for hazardous arcing may be different than the spectra for normal arcing. Arcing in light switches, arcing in bi-metallic switches in heating elements, and arcing during connection/disconnection of power cords, does not repeat during consecutive half-waves of an AC voltage. Each of these differences is an example of an electrical characteristic that can be measured. An electrical characteristic may be determined by Condition circuitry 118, or Controller 120 may receive waveform data and perform other operations on the data to determine a characteristic, or both. In this document, a set of electrical characteristics is called a signature. The Controller 120 determines whether a signature indicates hazardous arcing. If the signature indicates hazardous arcing, the Controller 120 uses Actuate circuitry 122 to open switch 108 to disconnect power to the load 106.

Circuit interrupter 100 may trip, and a consumer may determine that there is no actual hazardous arcing present, and that the interrupter is tripping falsely. The consumer may then manually activate a Learn Mode by activating a Learn Mode switch 124. There are several alternatives for Learn Mode. First, the controller may monitor and store characteristics, so that a signature corresponding to a tripping event is stored. Then, when Learn Mode is invoked, the controller may take action based on a stored signature. Alternatively, while in Learn Mode, the offending load may be plugged in or turned on. For either alternative, when Learn Mode is activated, the Controller 120 may modify the behavior of circuit interrupter 100 so that the probability of disconnecting power to the circuit being monitored is reduced. Controller 120 may modify an action associated with the electrical characteristics being measured, or the controller may modify various parameters within the Condition circuitry 118, or may change its firmware or data structures, or add a signature, or delete a signature, or modify a signature, to reduce the probability that the electrical characteristics being measured will cause tripping. Alternatively, Controller 120 may store characteristics measured during Learn Mode, transmit those characteristics to the manufacturer, and then receive updated firmware from the manufacturer. Note that the learning process may run independently of normal processing. That is, the circuit interrupter may continue to protect against arcing during Learn Mode.

Alternatively, circuit interrupter 100 may be installed with a dedicated load. For example, a receptacle may be dedicated to one appliance, for example a dishwasher, oven, dryer, furnace, or air conditioner. For a dedicated load, Learn Mode may be used to measure the normal signature for the dedicated load, and then the circuit interrupter may be put into a different operating mode in which any signature that significantly deviates from that normal signature causes tripping.

Circuit interrupter 100 may also optionally include failsafe circuitry 126. As will be discussed in more detail later below, the failsafe circuitry may be required by some safety agencies, and the failsafe circuitry may override the Controller 120.

Circuit interrupter 100 may also optionally include Communications circuitry 128. As will be discussed in more detail later below, the communications circuitry may be used to inform the manufacturer of changes made during Learn Mode, or of characteristics measured during Learn Mode, and may also be used to inform other circuit interrupters that may be affected by the changes.

Switch 124 may be a multi-purpose switch. It is common in AFCI devices to have a test switch. A consumer may activate the test switch to make sure the AFCI is working properly. A test switch may be used to also activate Learn Mode. For example, Controller 120 may activate a Learn Mode if switch 124 is closed for longer than a specified time. Alternatively, for example, Controller 120 may activate a Learn Mode if switch 124 is pressed twice within a specified time period. The controller may, for example, automatically return the circuit interrupter to normal operation after the Learn Mode process is completed, or after a fixed amount of time.

Circuit Interrupter 100 may also optionally include a status indicator 132. For example, a multi-colored LED or display or other indicator may indicate, for example, whether the Circuit Interrupter 100 is in a normal operating mode, in a tripped mode (and if tripped, whether it tripped due to excess current, leakage, or arcing), or in Learn Mode. An indicator may also indicate, for example, whether information is being or has been transmitted or received, whether the signature of a previous trip event is stored, whether or not there is a dedicated load, or whether its behavior has been modified as a result of a previous Learn Mode.

AFCI devices are commonly installed in residential environments. Accordingly, many of the examples in this document assume AC power. However, AFCI devices may also be installed in DC applications, for example, solar power panels or other renewable energy circuits, electric or hybrid automobiles, or aircraft or other transportation vehicles. Many of the examples of electrical characteristics, and determining whether a signature indicates hazardous arcing, apply equally to AC or DC.

Sensors 114 and 116 may detect the rate of change of current (di/dt). Sensors 114 and 116 may be, for example, transformer coupled ferrite rings (also known as cores), current transformers, shunt resistors, copper traces, Rogowski coils, Hall sensors, or fluxgates. Any type of signal coupling (direct, transformer, magnetic, electric field, etc.) may be used to couple the sensed signals to the Sensing circuitry 112. The Condition circuitry 118 may have, for example, one or more of the following circuits:

(a) Passband filters to determine the energy in the current spikes for various frequency ranges.
(b) Timers or phase-delay circuitry to determine a phase within an AC half-wave to initiate a measurement.
(c) Timers to determine a period within an AC half-wave to make a measurement.
(d) Counters to count current pulses within a period.
(e) Integrators to integrate current pulses over a period.
(f) Comparators to determine a distribution of current spike magnitudes.

Condition circuitry 118 may generate binary results, for example:

(A) The energy in frequency passband “A” is greater than threshold “W”.
(B) There is always a current spike during a period starting at phase “X”.
(C) The number of current spikes during a period is greater than “Y”.
(D) The integral of current spikes during a period is greater than “Z”.

The example electrical characteristics may be measured over multiple half-waves of an AC voltage, and the measurement over each half wave may be a separate characteristic. Each of the example electrical characteristics above is depicted as a binary value or “YES/NO” to the Controller 120. Alternatively, analog-to-digital converters may be used to generate numerical values, and various numerical values may be presented to the Controller 120, for example:

(A′) The integral of current in frequency passband “A” is “47”.
(B′) The number of current spikes during a period is “38”.
(C′) The integral of current spikes during a period is “61”.

Some basic signal processing may be provided by the Condition circuitry 118, and additional processing may be performed in the Controller 120 (for example, by processor firmware, or in a digital signal processor, or in an ASIC). For example, the Condition circuitry 118 may send raw information to the Controller 120 and the Controller 120 may count, integrate, filter, or perform other operations to determine electrical characteristics.

There are multiple algorithms a controller may use to determine whether a signature indicates the presence of hazardous arcing. Since AFCI algorithms are proprietary, and vary from manufacturer to manufacturer, the following alternative examples are just speculative possibilities to provide context for discussion of example changes that might be made in Learn Mode.

One example of a method to determine whether a signature indicates the presence of hazardous acing is to treat each characteristic as a bit in a binary number, and to associate a response (Disconnect/Don't-disconnect) for each possible resulting binary number. For example, assume characteristic “A” is the least significant bit, and characteristic “D” is the most significant bit. Further assume that A=0, B=1, C=0, and D=1. An example table might indicate that binary 1010 is a signature that indicates hazardous arcing, but binary 0111 is a signature that indicates normal operating conditions. Note, in general, a signature does not have to include all characteristics. That is, for a particular signature, some characteristics may be “Don't Care”.

Instead of associating an action with every possible combination of characteristics, the controller may only have a list of signatures that will result in a disconnect, and any signature not in that list is ignored. In the binary example given above, binary 1010 would be in the list, but not binary 0111.

Alternatively, for example, a weighted sum may be calculated. For example, characteristics indicating hazardous arcing may be given a positive value, characteristics indicating normal operation may be given a negative value, and each value may be multiplied by a weighting factor indicating relative importance. In this example, a positive weighted sum would indicate hazardous arcing.

Alternatively, the controller may execute a series of “IF-THEN-ELSE” steps. For example: IF current spikes are detected, THEN see if they are periodic, and THEN see if they always occur at the same phase, and so forth.

Alternatively, for example, for numerical values, a set of N numbers may represent a point in N-dimensional space. Controller 120 may have volumes in N-dimensional space (each characteristic may have a range) that are known signatures of hazardous arcing, and a set of volumes in N-dimensional space that are known signatures of normal operation. Given a measured signature, Controller 120 could compute the distance from the measured signature to the centroid of each of the known signatures and choose the response associated with the nearest known signature. Characteristics may also be weighted. Assume, for example, that A₁, B₁, C₁, and D₁ are the numerical coordinates of the centroid of a known signature in 4-dimensional space, A₂, B₂, C₂, and D₂ are measured numerical characteristics, and W_{A}, W_{B}, W_{C}, W_{D} are weighting factors. Distance may be computed as the square root of (W_{A}*(A₁-A₂)²+W_{B}*(B₁-B₂)²+W_{C}*(C₁-C₂)²+W_{D}*(D₁-D₂)²). In this example, smaller weights cause a smaller distance in N-dimensional space.

The immediately following discussion assumes that the circuit interrupter has tripped at least once, and the reason for invoking Learn Mode is to reduce the probability of tripping. There are many alternative ways the circuit interrupter can change its behavior to reduce the probability of tripping. For example, the following is a non-exhaustive list of alternatives:

1. Change an action associated with a signature.
2. Add a signature.
3. Delete a signature.
4. Modify a signature.
5. Change a parameter for determining an electrical characteristic.
6. Select a new set of parameters.
7. Select a new set of signatures.

The circuit interrupter may always trip, or the circuit interrupter may occasionally trip. The controller may take different approaches to reducing the probability of tripping, depending on which condition is present.

First, consider the case where the circuit interrupter always trips. In that case, the signature measured in Learn Mode (or a signature stored earlier in conjunction with a tripping even) will match an existing signature. If there is an action associated with the existing signature, the associated action may be changed from “Disconnect” to “Don't Disconnect”. In the binary example presented above, if the signature of the circuit during Learn Mode is 1010, then the action associated with signature 1010 may be changed. Alternatively, if there is just a list of signatures that result in disconnect, then a signature may be deleted from the list. In the binary example presented above, signature 1010 may be deleted from the list. Alternatively, the existing signature that matches the signature measured during Learn Mode may be modified. Assume for example, numerical characteristics. Further assume, for example, that for a known signature designating hazardous arcing that electrical characteristic “A” may be in the range of 50-100. Assume further that the measured value of electrical characteristic “A” is 60. The controller may, for example, modify the existing stored signature (with an associated action of “Disconnect”) so that characteristic “A” has a range of 75-100, and may, for example, create a new signature (with an associated action of “Don't-disconnect”) with characteristic “A” having a range of 50-75.

Now consider the case of intermittent tripping. If a signature was stored in conjunction with a tripping event, then that signature may be used as discussed above for the case where the interrupter always trips. If no signature is stored, then the circuit may not generate a hazardous arcing signature at the time Learn Mode is invoked, but may intermittently do so. The signature measured during Learn Mode may not match an existing signature that designates a disconnect action. In that case, the goal is to generally reduce the probability of tripping, and the signature measured during Learn Mode may or may not provide information on how to do that. One alternative is to change at least one parameter of a characteristic so that the circuit generates a different signature. Another alternative is to change the signatures.

In general, arc-fault testing is a matter of probabilities. If the circuit interrupter is programmed to detect a very high percentage of arc-faults, then it will also have a high probability of false tripping and nuisance tripping. Without a Learning Mode, a manufacturer may choose to lower the probability of false tripping and nuisance tripping to a commercially acceptable level, which may also lower the probability of detecting hazardous arcing. If a circuit interrupter has Learning Mode capability, a manufacturer may choose to pre-program the circuit interrupter with a higher probability of detecting hazardous arcing, knowing that Learning Mode can be used to reduce customer dissatisfaction with false tripping and nuisance tripping. For some customers, Learning Mode may never be needed. Learning Mode may only be needed for a small class of devices or appliances. Those customers not having the small class of devices or appliances may receive a higher level of protection than would be the case without Learning Mode.

In accordance with the above discussion of probabilities, the manufacturer may ship the circuit interrupter with parameter values or a set of signatures that intentionally provide a high probability of detecting hazardous arcing. The manufacturer may also determine, for example through testing, other sets of parameter values, or other sets of signatures, that reduce false tripping and nuisance tripping for certain classes of devices or appliances. In Learn Mode, if the measured or stored signature does not match an existing signature, then the controller may select from a predetermined set of parameter values, or select a different set of signatures from a predetermined set of signatures. The measured or stored signature may help determine the decision. The measured signature may not exactly match an existing signature, but might be close. The controller may then select a predetermined set of parameter values, or a predetermined set of signatures, based on the measured signature. For example, the signature may indicate a load having motor brushes, and there may be a set of values for the parameters, or a set of signatures, that is particularly suitable for motor brush loads. Or, the signature may indicate a light dimmer load, and another set of values for the parameters, or another set of signatures, may be particularly suitable for light dimmers, and so forth. Each AFCI may then be optimized for its particular load.

As discussed above, one way to reduce the probability of false tripping or nuisance tripping is to change the signature resulting from a circuit being monitored. For example, at least one variable parameter in at least one characteristic may be changed so that the resulting signature is changed. For example, in Learning Mode, Processer 120 may change various physical parameters used to determine electrical characteristics. Gains, bandwidths, starting times, periods, and thresholds, may all be variable parameters within the Condition circuitry 118. They may be made controllable by Controller 120. During Learning Mode, Controller 120 may change a pass band bandwidth of a filter, or may change a counter comparison threshold, or may change a voltage threshold, each of which affects the hardware measurement of an electrical characteristic. Alternatively, for example, Controller 120 may change internal firmware variable parameters. Counters, thresholds, integrators, etc. may be implemented in firmware. Controller 120 may internally compare numerical values received from the Condition circuitry 118 to internal numerical thresholds, and may change the internal numerical thresholds. For example, if the integral of current in frequency passband “A” is sent to Controller 120 as a numerical value, then Controller 120 may compare that numerical value to an internal threshold. During Learn Mode, Controller 120 may change that internal threshold. Likewise, the Controller 120 may change periods in software, or event starting times. Also, weights are internal variable parameters that can be changed in Learning Mode.

Parameters may also be changed during Learn Mode and then changed back to their original states. For example, instead of receiving filtered information, or bandwidth limited information, the controller may disable or bypass various analog circuitry and measure undistorted raw information with maximum fidelity.

In the example embodiment of FIG. 1, circuit interrupter 100 includes failsafe circuitry 126. In some applications of AFCI devices (for example, aircraft), or in some countries, an interrupter may be required by a safety agency to include a failsafe block that independently protects against catastrophic failures. In the example of FIG. 1, failsafe circuitry 126 can cause Actuate circuitry 122 to open switch 108 independently of the Controller 120. In general, a software based controller may not be deterministic, and a typical requirement for failsafe circuitry is that it must be deterministic and testable. Accordingly, a failsafe block typically includes electronic circuitry, but not a processor. The following is a non-exhaustive list of example fault/error conditions that a failsafe block might be required to detect:

1. Controller stuck or hung
2. Controller clock failure or incorrect frequency
3. Improper handling of interrupts by controller (no interrupt response or too frequent interrupts)
4. Single-bit fault in ROM or flash memory

### 5. Fault in RAM

6. External communication failure
7. Analog circuit failure
8. Failure of the low voltage power supply for the circuitry
9. Open circuit or dead driver for a trip solenoid
10. Self test failure

In FIG. 1, interrupter 100 is depicted as also including an optional communications circuit 128. The interrupter may communicate over the power lines (for example, Broadband over Power Lines, IEEE P1901), dedicated cables (for example, USB), wirelessly, or optically, or any other method. The interrupter may communicate externally (130), for example, with other interrupters, other safety devices (for example, smoke detectors or water leak detectors), with a home controller, with a manufacturer, or with a safety organization. Information to or from the interrupter may be compressed to decrease transmission time and to reduce local storage. With communication, the following enhancements may be provided:

1. The National Electrical Code Organization collects user reports of false tripping. The fact that a consumer has pressed a Learn Mode switch, and the resulting changes, may be transmitted (for example, over the Internet, or otherwise) to the National Electrical Code Organization, and to the manufacturer of the AFCI. Initiation of information transmission may be manual or automatic. Alternatively, as discussed below, if there is a home controller, a home controller may remotely initiate information transmission.
2. The AFCI may time-stamp and store arc-fault events, and record characteristics over time. This history could also be transmitted to the manufacturer in Learn Mode to facilitate improvement of algorithms.
3. It is possible to have a hierarchy of AFCI devices. For example, there may be an AFCI device in a power cord, which in turn is attached to an AFCI wall receptacle, which in turn is attached to an AFCI in a panel connected to main power. It is possible that invoking Learn Mode in the AFCI device in the power cord just causes false tripping or nuisance tripping to move “upstream” to the wall receptacle or breaker panel. With communication, the AFCI device may communicate the changes resulting from Learn Mode to other AFCI devices in the power path. Alternatively, for example, an AFCI device in a wall receptacle may communicate the changes resulting from Learn Mode to other AFCI devices in wall receptacles, so that an offending load can be moved from one receptacle to another without have to invoke Learn Mode again.
4. AFCI devices may be given an Internet Protocol (IP) address, or a Universal Resource Locator (URL), or other unique electronic identification, and receive information targeted to one specific AFCI or a family of AFCI devices. For example, based on a pattern of changes communicated to the manufacturer from Learn Mode, the manufacturer may send updated firmware to specific AFCI devices. Alternatively, the AFCI may request updated firmware during Learn Mode.
5. Instead of internally modifying signatures, an AFCI may send the measured characteristics and/or history to the manufacturer and rely on the manufacturer to update the firmware.

Interrupters with communications may also be used in conjunction with a home controller. The following is a non-exhaustive list of examples of communication between a home controller and interrupters.

1. A home controller may initiate Learn Mode.
2. A home controller may control all communication from an interrupter to the outside (for example, information to the National Electrical Code Organization, or to the manufacturer).
3. A home controller may communicate to selected interrupters to cut power in response to a request from a power company to reduce power.
4. Smoke and fire detectors may instruct selected interrupters to shut off. For example, heavy loads could be shut down in case of fire. Alternatively, wall outlets and ceiling lamps may be on separate networks, and wall outlets could be shut down in case of fire, but ceiling lamps left on to facilitate exit.
5. A commercial water leak detector may instruct an interrupter to cut power to the main water supply valve and to all wall outlets.
6. Interrupters may measure power consumption and communicate power consumption to a home controller, either in real time, or they may store power consumption and communicate periodically or in response to a request.
7. Interrupters may automatically run self test, or in response to a request from a home controller, and report the results of self test.
8. Interrupters may be automatically monitored by a safety agency, or may periodically report to a safety agency.

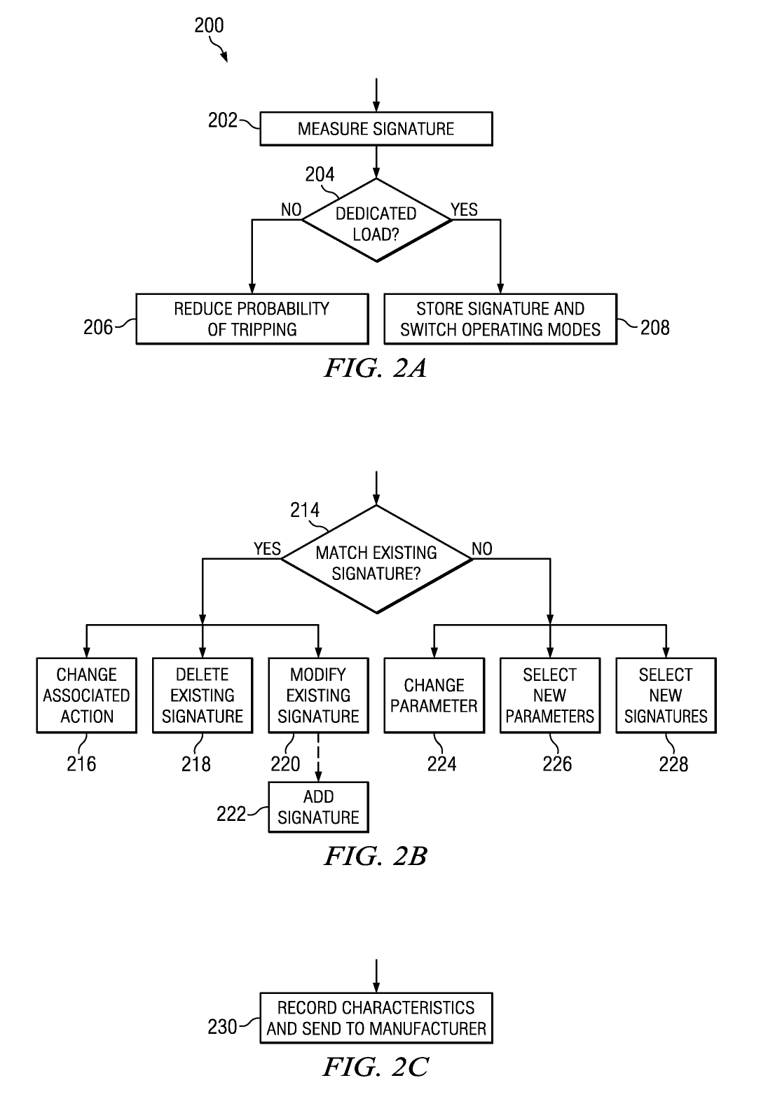

FIG. 2A is a flow chart of an example method 200 for the circuit interrupter when in Learn Mode. Note, arrangement of steps in the flow chart does not imply a required order of steps, some steps may occur simultaneously, and not all steps are required. At step 202, Controller 120 determines the signature of the circuit. At step 204, the controller determines whether the circuit interrupter is being installed with a dedicated load. If no dedicated load is indicated, then at step 206 the controller reduces the probability of tripping. If a dedicated load is indicated, then at step 208 the signature is stored and the controller switches to a different mode of operation.

Some example alternatives for step 206 in FIG. 2A are illustrated in FIG. 2B. At step 214, the controller determines whether the signature measured at step 202 of FIG. 2A matches an existing signature. If so, the controller may, for example, take one of three actions (or some combination), depending on the nature of the algorithm being used by the AFCI. The controller may change the action associated with the existing signature (step 216), or the controller may delete the existing signature (step 218), or the controller may modify the existing signature (220). Optionally, if a signature is modified, the controller may also add a new signature (222). If at step 214, the controller determines that the signature measured at step 202 of FIG. 2A does not match an existing signature, then the controller may, for example, take one of three actions (or some combination). At least one physical or logical parameter of at least one characteristic may be changed (step 224) so that the circuit generates a different signature. Alternatively, the controller may select a different set of parameters from a predetermined set of parameters (step 226), or may select a different set of signatures from a predetermined set of signatures (step 228).

FIG. 2C illustrates another alternative example embodiment of step 206 in FIG. 2A. At step 230, instead of internally modifying actions, signatures, parameters, or firmware, the AFCI may measure and store the characteristics of the circuit and transmit the measurements to the manufacturer. Updated firmware may then be provided by the manufacturer.

In FIG. 2A, step 204 determines whether the AFCI has a dedicated load. One example method is to record any tripping, and at step 204 determine whether the AFCI has ever tripped in the past. Alternatively, separate switches may be provided, or the test switch may be used to select among multiple options. If the AFCI has not previously tripped, then the Controller 120 may assume that the intent of pressing the Learn Mode switch is to learn the normal signature of a dedicated load. At step 208, the signature from step 202 is stored as a known signature for normal operating conditions. At step 208, the AFCI is placed into an operating mode where any new measured signature may be compared only to the one known signature for normal operations, and any significant deviation may result in tripping.

The circumstances requiring a consumer to select Learn Mode may be temporary. That is, a particular device or appliance may be used for a period of time, and then be disconnected permanently. There are also circumstances in which it would be desirable to temporarily disable the AFCI. For example, a consumer may need to temporarily use an arc-welder. There is probably no practical way to distinguish an arc-welder from hazardous arcing. If Learn Mode changes the action associated with a signature, then Learn Mode can be used to effectively disable an AFCI when an arc-welder is being used. For these and other situations, it would desirable to have a way to return the AFCI to factory settings. Switch 114 in FIG. 1 could be used to invoke still another mode. For example, if the switch is actuated for an even longer period time than the time specified for Learn Mode, the controller may invoke a Restore mode to return the AFCI to factory settings instead of invoking Learn Mode. Alternatively, for example, pressing the switch more than two times in a specified time period could activate the Restore mode. In Restore mode, any changes to the action associated with a signature, or any changes to variable parameters, or any adding or deleting of signatures, or any other changes made during a previous Learn Mode, would be reversed.

AFCI devices may be used in commercial environments, industrial environments, and residential environments. AFCI devices may be used in vehicles, particularly electric and hybrid vehicles, and in aircraft. AFCI devices may be used in electrical panels connected to main power, or in wall outlets, in extension cords, or in appliances or other devices. AFCI devices may be used in solar panels, wind generators, and other renewable power sources. Arc-fault interruption may be combined with other modes of interruption. A Learn Mode is applicable to all applications of AFCI devices. Learn Mode may be added to existing devices. Many existing AFCI devices include a processor and a Test switch, so that only a firmware change is needed.

Although the invention has been described in detail, it should be understood that various changes, substitutions and alterations can be made thereto without departing from the spirit and scope of the invention as defined by the appended claims.

What is claimed is:

1. An arc-fault circuit-interrupter, comprising:
a controller adapted to interrupt power when a hazardous arc is detected; and,
the controller adapted to include a learn mode.

2. The arc-fault circuit-interrupter of claim 1, further comprising:
the controller adapted to lower the probability of interrupting power, when in learn mode.

3. The arc-fault circuit-interrupter of claim 2, further comprising:
the controller adapted to change an action associated with a signature when in learn mode.

4. The arc-fault circuit-interrupter of claim 2, further comprising:
the controller adapted to delete a signature when in learn mode.

5. The arc-fault circuit-interrupter of claim 2, further comprising:
the controller adapted to modify a signature when in learn mode.

6. The arc-fault circuit-interrupter of claim 2, further comprising:
the controller adapted to add a signature when in learn mode.

7. The arc-fault circuit-interrupter of claim 2, further comprising:
the controller adapted to change variable parameters to a pre-determined set of variable parameters, when in learn mode.

8. The arc-fault circuit-interrupter of claim 2, further comprising:
the controller adapted to change a set of signatures to a pre-determined set of signatures, when in learn mode.

9. The arc-fault circuit-interrupter of claim 1, further comprising:
the controller adapted to measure first electrical characteristics when in learn mode, and to measure second electrical characteristics when not in learn mode, and to interrupt a circuit when the second electrical characteristics are significantly different than the first electrical characteristics.

10. The arc-fault circuit-interrupter of claim 1, further comprising:
a switch; and,
the controller adapted to go into learn mode in response to actuation of the switch.

11. The arc-fault circuit-interrupter of claim 1, further comprising:
the controller adapted to return to a normal operating mode automatically on completion of learn mode.

12. The arc-fault circuit-interrupter of claim 1, further comprising:
the controller adapted to run learn mode firmware while still running normal operating firmware.

13. The arc-fault circuit-interrupter of claim 1, further comprising:
communications circuitry.

14. The arc-fault circuit-interrupter of claim 13, further comprising:
the controller adapted to measure electrical characteristics in learn mode; and,
the controller adapted to transmit the measured electrical characteristics.

15. The arc-fault circuit-interrupter of claim 13, further comprising:
the communications circuitry transmitting changes made during learn mode.

16. The arc-fault circuit-interrupter of claim 13, further comprising:
the communications circuitry transmitting fault history during learn mode.

17. A method of controlling an arc-fault circuit-interrupter, comprising:
measuring, by the controller, electrical characteristics;
changing, by the controller, in a learn mode, the firmware for the controller in response to the electrical characteristics.

18. The method of claim 17, the step of changing further comprising:
reducing, by the controller, the probability of circuit-interrupting by the arc-fault circuit-interrupter.

19. The method of claim 17, the step of changing further comprising:
storing, by the controller, the electrical characteristics as first electrical characteristics;
exiting, by the controller, learn mode;
measuring, by the controller, second electrical characteristics; and,
interrupting, by the arc-fault circuit interrupter, a circuit when the second electrical characteristics are substantially different than the first electrical characteristics.

20. A method of controlling an arc-fault circuit-interrupter, comprising:
entering, by a controller, a learn mode;
measuring, by the controller, electrical characteristics; and,
communicating, by the controller, the measured electrical characteristics.
